(19) United States
(12) Patent Application Publication
(10) Pub. No.: US 2012/0004919 A1
(43) Pub. Date: Jan. 5, 2012

(54) THREE-DIMENSIONAL GLASSES WITH BLUETOOTH AUDIO DECODE

(75) Inventor: James Michael Muth, Santa Ana, CA (US)

(73) Assignee: BROADCOM CORPORATION, Irvine, CA (US)

(21) Appl. No.: 12/878,735

(22) Filed: Sep. 9, 2010

Related U.S. Application Data
(60) Provisional application No. 61/360,070, filed on Jun. 30, 2010.

(51) Int. Cl. H04N 13/04; G10L 19/00

(52) U.S. Cl. 704/500; 348/56; 348/E13.036; 704/E19.001

(57) ABSTRACT

Audio associated with three-dimensional image content is enabled to be heard by a user without interfering with other users. A device network includes a display system (master) and a wearable device (slave). The wearable device includes a glasses frame, earphones, and left and right eye shuttering lenses. The wearable device receives from the display system a frame sync signal and audio content associated with three-dimensional image content displayed by the display system as alternating left and right images. The audio content is played using the earphone. The left and right eye shuttering lens are shuttered in synchronism with the alternating left and right images according to the frame sync signal to enable a wearer of the wearable device to perceive the alternating left and right images as a three-dimensional image. Additional wearable devices may join the device network to be delivered independent audio and three-dimensional content in a similar manner.

This application claims the benefit of U.S. Provisional Application No. 61/360,070, filed on Jun. 30, 2010, which is incorporated by reference herein in its entirety.

### BACKGROUND OF THE INVENTION

1. Field of the Invention

The present invention relates to three-dimensional display technology.

2. Background Art

Images may be generated for display in various forms. For instance, television (TV) is a widely used telecommunication medium for transmitting and displaying images in monochromatic (“black and white”) or color form. Conventionally, images are provided in analog form and are displayed by display devices in two-dimensions. More recently, images are being provided in digital form for display in two-dimensions on display devices having improved resolution (e.g., “high definition” or “HD”). Even more recently, images capable of being displayed in three-dimensions are being generated.

Conventional displays may use a variety of techniques to achieve three-dimensional image viewing functionality. For example, various types of glasses have been developed that may be worn by users to view three-dimensional images displayed by a conventional display. Examples of such glasses include glasses that utilize color filters or polarized filters. In each case, the lenses of the glasses pass two-dimensional images of differing perspective to the user's left and right eyes. The images are combined in the visual center of the brain of the user to be perceived as a three-dimensional image. In another example, synchronized left eye, right eye LCD (liquid crystal display) shutter glasses may be used with conventional two-dimensional displays to create a three-dimensional viewing illusion. In still another example, LCD display glasses are being used to display three-dimensional images to a user. The lenses of the LCD display glasses include corresponding displays that provide images of differing perspective to the user's eyes, to be perceived by the user as three-dimensional.

Difficulties exist in providing audio associated with delivered three-dimensional or two-dimensional content, such as content provided to shutter glasses. Such audio is desired to be provided in a manner that it does not disturb other persons who may not be viewing the same three-dimensional content or two-dimensional content.

### BRIEF SUMMARY OF THE INVENTION

Methods, systems, and apparatuses are described for display systems and wearable devices that enable audio associated with three-dimensional or two-dimensional image content to be heard by viewers without interfering with other persons substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a display environment, according to an example embodiment.

FIG. 2 shows a pair of 3D (three-dimensional) enabled glasses, according to an example embodiment.

FIGS. 3-5 each show a respective block diagram example of the display environment of FIG. 1, according to embodiments.

FIG. 6 shows a flowchart for providing first three-dimensional content to a first user that wears a first wearable device, according to an example embodiment.

FIG. 7 shows a flowchart for providing second three-dimensional content to a second user that wears a second wearable device, simultaneously with first three-dimensional content being provided to a first user that wears a first wearable device, according to an example embodiment.

FIG. 8 shows a block diagram of communication system that includes 3D enabled glasses and a display system, according to an example embodiment.

FIG. 9 shows a timeline illustrating a timing of right and left images displayed on a display panel, according to an example embodiment.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,”etc.) used herein are for purposes of illustration only, and that practical implementations of the structures described herein can be spatially arranged in any orientation or manner.

### Example Embodiments

There is a huge industry push to support three-dimensional images being displayed by a digital television (DTV) or by other types of display devices to viewers. One technique for providing three-dimensional images involves shuttering of the right and left lenses of glasses (e.g., goggles) worn by a viewer (or “wearer”), the shuttering being perform in sync with the display of image on a display. In such shutter glasses, a left image is displayed on the screen that is coordinated with a blackout on the right lens of the glasses (so that the left image is only seen by the left eye of the viewer), followed by a right image being displayed on the screen that is coordinated with a blackout on the left lens of the glasses (so that the right image is only seen by the right eye of the viewer).

Difficulties exist in enabling a viewer to listen to audio associated with such three-dimensional content being viewed without disturbing other persons that are nearby. Furthermore, a display may be configured to provide three-dimensional or two-dimensional views to multiple viewers, such that each viewer is enabled to see their own selected three-dimensional content without seeing the content viewed by other viewers. However, in such case, difficulties exist in enabling each viewer to hear the audio associated with their own three-dimensional view without hearing audio associated with the other three-dimensional views.

In embodiments, as described herein, glasses are provided that deliver three-dimensional content to a wearer and/or enables the wearer to have a personal listening experience. For instance, if the user is watching television using the glasses, the user does not disturb other persons who may be viewing other content, may be performing other activity nearby, may be sleeping, etc.

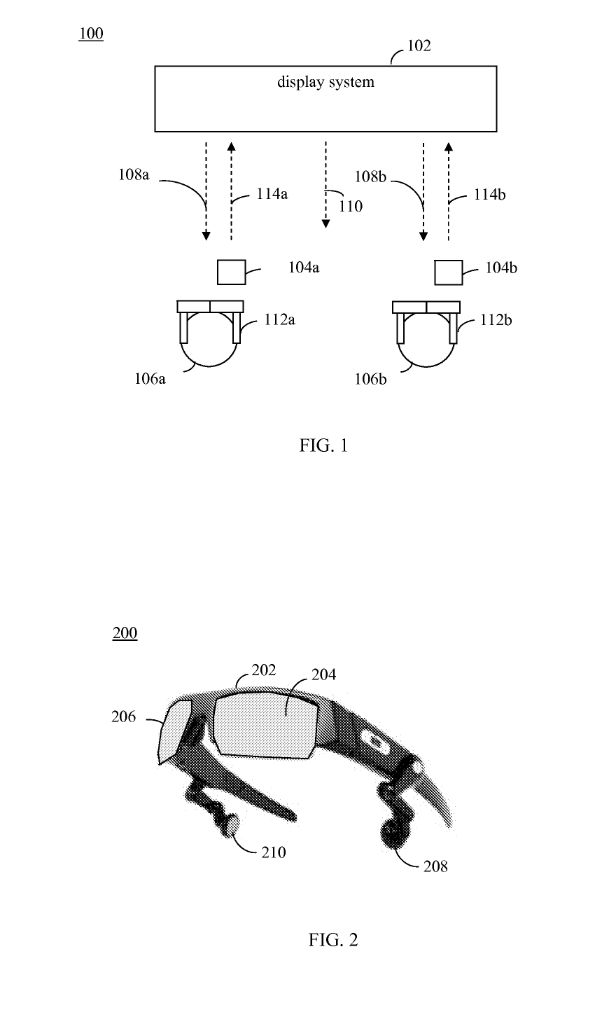

For instance, FIG. 1 shows a block diagram of a display environment 100, according to an example embodiment. In the example of FIG. 1, first and second viewers 106a and 106b are present in display environment 100, and are enabled to interact with a display system 102 to be delivered three-dimensional or other media content. Although two viewers 106 are shown present in FIG. 1, in other embodiments, other numbers of viewers 106 may be present in display environment 100 that may interact with display system 102 and may be delivered media content by display system 102, including a single viewer 106, or additional numbers of viewers 106. As shown in FIG. 1, display environment 100 includes display system 102, a first remote control 104a, a second remote control 104b, a first glasses 112a, a second glasses 112b, and first and second viewers 106a and 106b.

Display system 102 is a system configured to display images. For example, display system 102 may include a display device, such as a television display, a computer monitor, a smart phone display, etc., and may include one or more devices configured to provide media content to the display device, such as a computer, a cable box or set top box, a game console, a digital video disc (DVD) player, a home theater receiver, etc. In an embodiment, the display device and a media content receiver and/or player may be integrated in a single device or may be separate devices. A display device of display system displays light 110 that includes three-dimensional/two-dimensional images associated with three-dimensional/two dimensional content selected by viewers 106a and 106b for viewing. For example, viewer 106a may use remote control 104a to select the first content for viewing, and viewer 106b may use remote control 104b to select the second content for viewing. In an embodiment, remote control 104a and remote control 104b may be integrated into a single device or may be two separate devices. As shown in FIG. 1, remote control 104a may transmit a first content selection signal 114a that indicates content for viewing selected by viewer 106a, and remote control 104b may transmit a second content selection signal 114b that indicates content for viewing selected by viewer 106b.

Viewer 106a is delivered a corresponding view 108a by display system 102, and viewer 106b is delivered a corresponding view 108b by display system 102. Views 108a and 108b may each be a three dimensional view. In embodiments, view 108a may be delivered to viewer 106a, but not be visible by viewer 106b, and view 108b may be delivered to viewer 106b, but not be visible by viewer 106a. In embodiments, views 108a and 108b may be different or the same.

First and second glasses 112a and 112b are shutter glasses that enable personal viewing, 3D viewing, or both personal and 3D viewing. As such, each of first and second glasses 112a and 112b filters the images displayed by display system 102 so that each of viewers 106a and 106b is delivered a particular three-dimensional or two-dimensional view associated with the three-dimensional or two dimensional content that the viewer selected.

For instance, display system 102 may emit light 110 that includes first and second images associated with the first three-dimensional content selected by viewer 106a and third and fourth images associated with the second three-dimensional content selected by viewer 106b. The first image is a left eye image and the second image is a right eye image associated with the first three-dimensional content, and the third image is a left eye image and the fourth image is a right eye image associated with the second three-dimensional content. The first-fourth images may be sequentially displayed by display system 102 in a repeating fashion, with each repeated display of each of the first-fourth images providing a next image in four sequences of images. First and second glasses 112a and 112b operate to filter the first-fourth images displayed by display system 102 so that viewers 106a and 106b are enabled to view the corresponding three-dimensional content they desire to view. For example, the left and right lens of first glasses 112a block or pass light 110 in synchronization with the first and second images, respectively, and the left and right lens of second glasses 112b block or pass light 110 in synchronization with the third and fourth images. In this manner, first viewer 106a alternately sees the first image with his/her left eye and the second image with his/her right eye, and second viewer 106b alternately sees the third image with his/her left eye and the fourth image with his/her right eye. The first and second images are combined in the visual center of the brain of viewer 106a to be perceived as a first three-dimensional image, and the third and fourth images are combined in the visual center of the brain of viewer 106b to be perceived as a three-dimensional image.

In another embodiment, display system 102 may provide two-dimensional views to viewers 106a and 106b. For instance, display system 102 may emit light 110 that includes a first image associated with the first content selected by viewer 106a and a second image associated with the second content selected by viewer 106b. The first image is associated with the first content, and the second image is associated with the second content. The first and second images may be sequentially displayed by display system 102 in a repeating fashion, with each repeated display of each of the first and second images providing a next image in two sequences of images. First and second glasses 112a and 112b operate to filter the first and second images displayed by display system 102 so that viewers 106a and 106b are enabled to view the corresponding content they desire to view. For example, the left and right lens of first glasses 112a block or pass light 110 in synchronization with the first image, and the left and right lens of second glasses 112b block or pass light 110 in synchronization with the second image. In this manner, viewer 106a views a sequence of the first images to be provided a first two-dimensional view, and viewer 106b views a sequence of the second images to be provided a second two-dimensional view.

In another embodiment, one of first and second glasses 112a and 112b provides one of viewers 106a and 106b with a two-dimensional view, while the other of first and second glasses 112a and 112b provides one of viewers 106a and 106b with a three-dimensional view.

Furthermore, first and second glasses 112a and 112b each include one or more earphones that enable viewers 106a and 106b to hear the audio associated with their corresponding content being viewed. If the content selected to be presented by first and second glasses 112a and 112b is the same, first and second glasses 112a and 112b provide the same audio content to viewers 106a and 106b associated with the content selected to be viewed. If the content selected to be viewed by first and second glasses 112a and 112b is not the same, first and second glasses 112a and 112b respectively provide the corresponding audio content associated with the particular content selected to be viewed. In this manner, viewers 106a and 106b hear their own respective audio, and are not disturbed by the other viewer's audio.

Glasses 112a and 112b may be configured in various ways. For instance, FIG. 2 shows a pair of glasses 200, according to an example embodiment. Glasses 200 are 3D-enabled, and are an example of first and second glasses 112a and 112b of FIG. 1. As shown in FIG. 2, glasses 200 includes a glasses frame 202, a left shuttering lens 204, a right shuttering lens 206, a left earphone 208, and a right earphone 210. Left and right shuttering lenses 204 and 206 are configured to alternately pass or block light 110 in synchronism with the images displayed by display device 100 to deliver a three-dimensional or two-dimensional view to the wearer of glasses 200. A receiver (not shown in FIG. 2) of glasses 200 is configured to receive an audio content signal associated with the view from display system 102, and earphones 208 and 210 enable the wearer of glasses 200 to hear the corresponding audio.

Note that the configuration of glasses 200 shown in FIG. 2 is provided for purposes of illustration, and is not intended to be limiting. In embodiments, glasses 112/200 may have other configurations, including other sizes, shapes, dimensions, and/or features, as would be known to persons skilled in the relevant art(s).

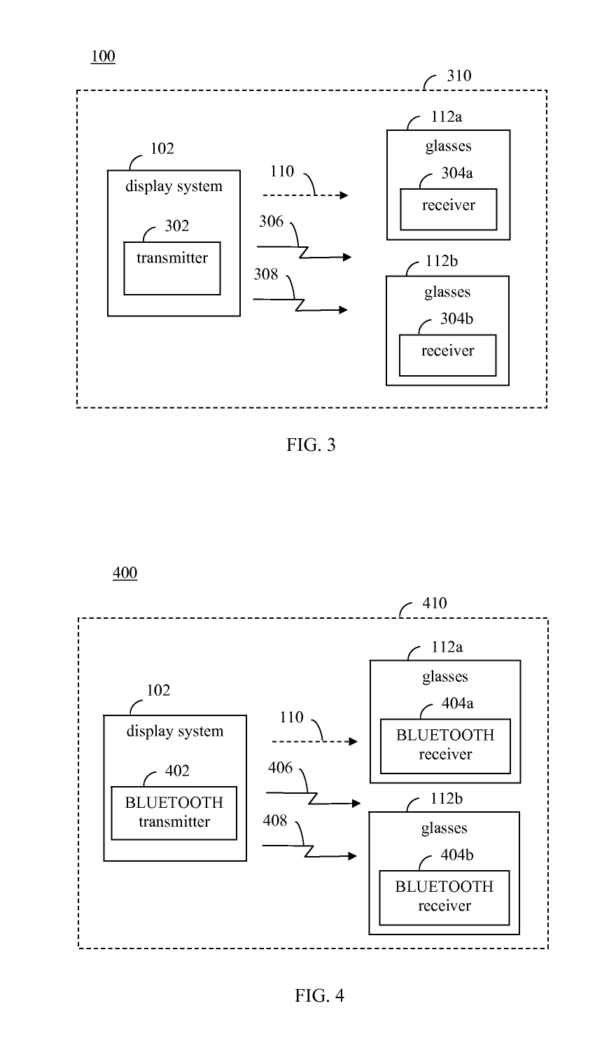

FIG. 3 shows display environment 100, according to an example embodiment. As shown in FIG. 3, display environment 100 includes display system 102, first glasses 112a, and second glasses 112b. Furthermore, display system 102 includes a transmitter 302, first glasses 112a includes a receiver 304a, and second glasses 112b includes a receiver 304b. Display system 102, first glasses 112a, and second glasses 112b form a device network 310, such as piconet or personal area network (PAN). In device network 310, display system 102 functions as a master device, and first and second glasses 112a and 112b each function as slave devices. As described above with respect to FIG. 1, display system 102 emits light 110 (in FIG. 1) that includes images that glasses 112a and 112b deliver to viewers 106a and 106b as three-dimensional images. Furthermore, display system 102 transmits a frame sync signal 306 to glasses 112a and 112b. Frame sync signal 306 is a signal synchronized with the display of the images by display system 102. Glasses 112a and 112b use frame sync signal 306 to synchronize the blocking and passing of light 110 by their right and left shuttering lenses to enable the images displayed by display system 102 to be perceived as three-dimensional. Frame sync signal 306 may be transmitted as an IR (infrared signal), an RF (radio frequency) signal, or in other form.

Still further, transmitter 302 transmits an audio content signal 308. Receivers 304a and 304b of glasses 304a and 304b receive audio content signal 308. When glasses 112a and 112b display the same content to their wearers, audio content signal 308 includes the same audio content for both receiver 304a and 304b. Glasses 112a and 112b extract the audio content from audio content signal 308, and use their respective earphones to play the extracted audio content to their wearers. When glasses 112a and 112b display different content to their wearers, audio content signal 308 includes first and second audio content associated with the first and second content. Glasses 112a extract the first audio content from audio content signal 308, and uses its earphones to play the extracted first audio content to its wearer. Glasses 112b extracts the second audio content from audio content signal 308, and uses its earphones to play the extracted second audio content to its wearer.

Transmitter 302 and receivers 304a and 304b may communicate according to any suitable communication protocol, such as an 802.11 WLAN (wireless local area network) communication protocol (“WiFi”), an 802.15.4 WPAN (wireless personal area network) protocol (e.g., “ZigBee”), or other communication protocol. In an embodiment, transmitter 302 and receivers 304a and 304b communicate according to the Bluetooth™ communication protocol. For instance, FIG. 4 shows a display environment 400, according to an example embodiment. Display environment 400 is an example of display environment 100, where display system 102 and glasses 112a and 112b are configured to communicate according to the Bluetooth™ communication protocol. For example, Bluetooth™ transmitter 402 and Bluetooth™ receivers 404a and 404b may form a Bluetooth™ piconet 410, where display system 102 is the master device, and glasses 112a and 112b are slave devices. A piconet is an ad-hoc computer network linking a group of devices. As shown in FIG. 4, display system 102 includes a Bluetooth™ transmitter 402, glasses 112a includes a Bluetooth™ receiver 404a, and glasses 112b includes a Bluetooth™ receiver 404b. In FIG. 4, a communication channel 406 is established between Bluetooth™ transmitter 402 and Bluetooth™ receivers 404a and 404b. In an embodiment, communication channel 406 may be a Bluetooth™ Human Interface Device (HID) channel. Such a channel may carry the synchronization signal for opening and closing the shutters of glasses 112a and 112b.

In an embodiment where glasses 112a and 112b display the same content to their wearers, Bluetooth™ transmitter 402 transmits an audio content signal 408 that includes the associated audio content across communication channel 406, which is received by Bluetooth™ receivers 404a and 404b. The audio content of audio content signal 418 may be transmitted as native Advanced Audio Distribution Profile (A2DP) data, as SBC (subband codec) encoded data that is inserted into HID (human interface device) packets, or may be transmitted in other form. Glasses 112a and 112b extract the audio content from audio content signal 408, and use their respective earphones to play the extracted audio content to their wearers. Furthermore, in an embodiment, Bluetooth™ transmitter 402 may optionally transmit frame sync signal 306 across a communication channel 406 established between Bluetooth™ transmitter 402 and Bluetooth™ receivers 404a and 404b. Communication channel 406 containing a synchronization signal similar to frame sync signal 306 is received by Bluetooth™ receivers 404a and 404b. As described above, glasses 112a and 112b may use frame sync signal 306 to synchronize the blocking and passing of light 110 by their right and left shuttering lenses to enable the images displayed by display system 102 to be perceived as three-dimensional. In an embodiment, communication channel 406 may be a Bluetooth™ HID link.

In a current Bluetooth™ piconet implementation, up to seven glasses 112 may be present that are separately linked with display system 102 (there may be eight total members of the piconet including seven glasses 112 and display system 102), but in other embodiments, additional glasses 112 may be present.

In another embodiment, separate communication channels may be established between Bluetooth™ transmitter 402 and Bluetooth™ receiver 404a and between Bluetooth™ transmitter 402 and Bluetooth™ receiver 404b. Such an embodiment may be used when glasses 112a and 112b may display different content to their wearers, and thus, different audio content is transmitted to glasses 112a and 112b by display device 102 over the separate communication channels.

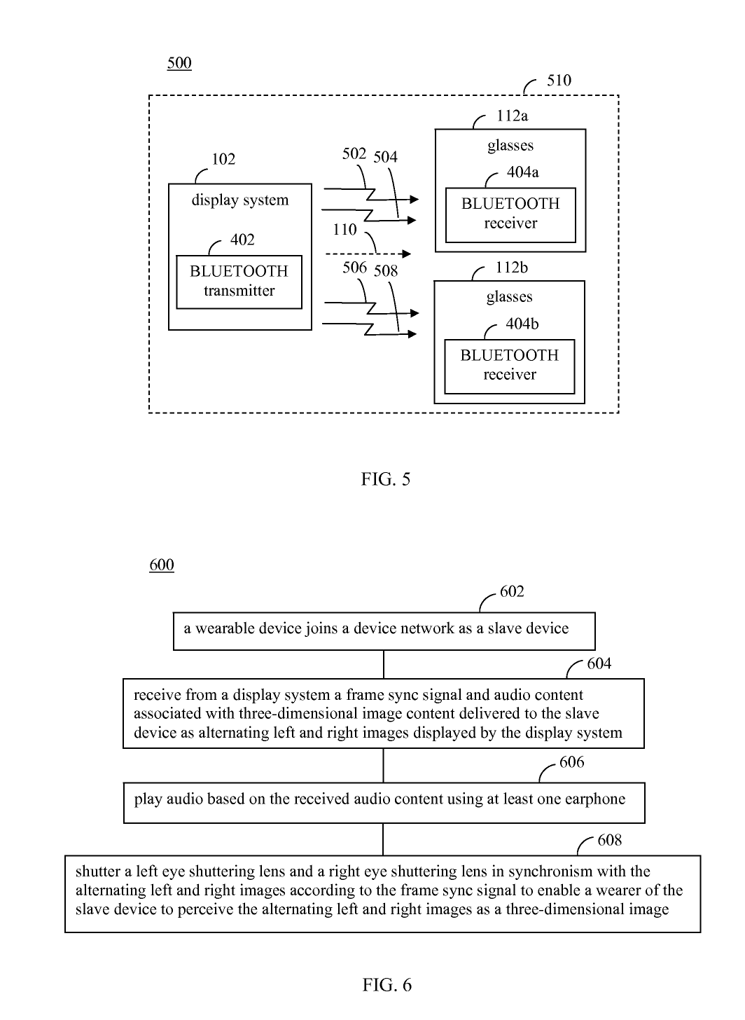

For example, FIG. 5 shows a display environment 500, according to an example embodiment. Display environment 500 is similar to display environment 400 of FIG. 4, including display system 102 and glasses 112a and 112b configured to communicate according to the Bluetooth™ communication protocol. As shown in FIG. 5, display system 102 includes Bluetooth™ transmitter 402, glasses 112a includes Bluetooth™ receiver 404a, and glasses 112b includes Bluetooth™ receiver 404b. Bluetooth™ transmitter 402 and Bluetooth™ receivers 404a and 404b may form a Bluetooth™ piconet 510, as described above. In FIG. 5, a first communication channel 502 and a second communication channel 504 are established between Bluetooth™ transmitter 402 and Bluetooth™ receiver 404a, and a third communication channel 506 and a fourth communication channel 508 are established between Bluetooth™ transmitter 402 and Bluetooth™ receiver 404b. In an embodiment, first and third communication channels 502 and 506 may be Bluetooth™ HID channels that are capable of carrying shutter glasses open/close synchronization information, and second and fourth communication channels 504 and 508 may be Bluetooth™ A2DP channels that are capable of carrying stereo audio information. Signals may be transmitted over communication channels 502, 504, 506, and 508 in a unicast (point-to-point) or broadcast manner.

Bluetooth™ transmitter 402 transmits a first synchronization signal across communication channel 502 that includes the shutter glass information for the wearer of first glasses 112a, and transmits audio content across communication channel 504 that is associated with the content being viewed by the wearer of first glasses 112a. The audio content may be transmitted as native A2DP data, as SBC (subband codec) encoded data that is inserted into HID (human interface device) packets, or may be transmitted in other form. The first audio content signal and the first synchronization signal are received by Bluetooth™ receiver 404a. Glasses 112a may use a frame sync signal included in the first synchronization signal to synchronize the blocking and passing of light 110 by the right and left shuttering lenses of glasses 112a to enable the corresponding images displayed by display system 102 to be perceived as three-dimensional or two dimensional by the wearer of glasses 112a. Furthermore, glasses 112a extract the audio content from the first audio content signal, and play the extracted audio content to the wearer of glasses 112a.

Likewise, Bluetooth™ transmitter 402 transmits a second audio content signal across communication channel 508 that includes the audio content associated with the content being viewed by the wearer of second glasses 112b, and transmits a second synchronization signal across communication channel 506 that is associated with the content being viewed by the wearer of second glasses 112b. The second audio content signal and the second synchronization signal are received by Bluetooth™ receiver 404b. Glasses 112b may use a frame sync signal included in the second synchronization signal to synchronize the blocking and passing of light 110 by the right and left shuttering lenses of glasses 112b to enable the corresponding images displayed by display system 102 to be perceived as three-dimensional or two dimensional by the wearer of glasses 112b. Furthermore, glasses 112b extract the audio content from the second audio content signal, and play the extracted audio content to the wearer of glasses 112b.

Thus, through the use of wearable devices such as glasses 112, three-dimensional content may be provided to one or more users that view a display device of a display system. For instance, FIG. 6 shows a flowchart 600 for providing first three-dimensional content to a first user that wears a first wearable device, according to an example embodiment. Flowchart 600 is described as follows with respect to glasses 112a of FIG. 5, for illustrative purposes. Further structural and operational embodiments will be apparent to persons skilled in the relevant art(s) based on the following description of flowchart 600.

Flowchart 600 begins with step 602. In step 602, a wearable device joins a device network as a slave device. For example, as shown in FIG. 5, glasses 112a may join piconet 510 as a slave device by linking with display system 102, which is the master device of piconet 510. Glasses 112a may join piconet 510 in any manner, such as according to a Bluetooth™ protocol, as would be known to persons skilled in the relevant art(s).

In step 604, a frame sync signal and audio content are received from a display system, the audio content being associated with three-dimensional image content delivered to the slave device as alternating left and right images displayed by the display system. For example, as described above, receiver 404a of glasses 112a may receive first communication channel 502 that carries a frame sync signal, and may receive second communication channel 504 that carries audio content. The audio content received in second communication channel 504 is associated with three-dimensional image content displayed by display system 102 as alternating left and right images.

In step 606, audio based on the received audio content is played using at least one earphone. For example, as described above, one or both earphones of glasses 112a may play audio based on the audio content received in second communication channel 504.

In step 608, a left eye shuttering lens and a right eye shuttering lens are shuttered in synchronism with the alternating left and right images according to the frame sync signal to enable a wearer of the slave device to perceive the alternating left and right images as a three-dimensional image. For example, as described above, a left eye shuttering lens and a right eye shuttering lens of glasses 112a may be shuttering in synchronism with the alternating left and right images displayed by display system 102. The frame sync signal provided in first communication channel 502 causes the left eye shuttering lens to be open and the right eye shuttering lens to be closed when the left image is displayed by display system 102, and causes the left eye shuttering lens to be closed and the right eye shuttering lens to be open when the right image is displayed by display system 102.

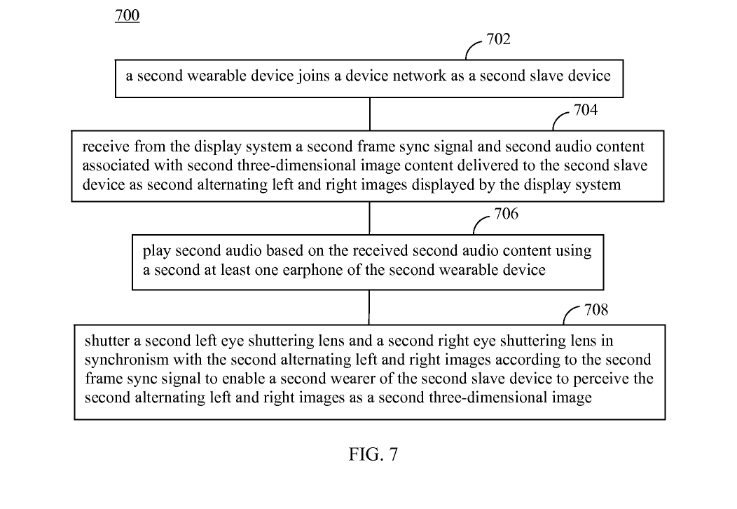

Thus, a first user that wears glasses 112a may be delivered three-dimensional content by display system 102. As shown in FIG. 5, a second pair of glasses 112b may be used to enable three-dimensional content to be provided to a second viewer of display system 102. For instance, FIG. 7 shows a flowchart 700 for providing second three-dimensional content to a second user that wears a second wearable device, simultaneously with the first three-dimensional content being provided to the first user (e.g., according to flowchart 600 of FIG. 6), according to an example embodiment. Flowchart 700 is described as follows with respect to glasses 112b of FIG. 5, for illustrative purposes. Further structural and operational embodiments will be apparent to persons skilled in the relevant art(s) based on the following description of flowchart 700.

Flowchart 700 begins with step 702. In step 702, a second wearable device joins the device network as a second slave device. For example, as shown in FIG. 5, glasses 112b may join piconet 510 as a second slave device by linking with display system 102. Glasses 112b may join piconet 510 in any manner, such as according to a Bluetooth™ protocol, as would be known to persons skilled in the relevant art(s).

In step 704, a second frame sync signal and second audio content are received from a display system, the second audio content being associated with second three-dimensional image content delivered to the second slave device as second alternating left and right images displayed by the display system. For example, as described above, receiver 404b of glasses 112b may receive third communication channel 506 that carries the frame sync signal, and may receive fourth communication channel 508 that carries the second audio content. The second audio content received in fourth communication channel 508 is associated with second three-dimensional image content displayed by display system 102 as a second set of alternating left and right images.

In step 706, second audio based on the received second audio content is played using at least one earphone of the second wearable device. For example, as described above, one or both earphones of glasses 112b may play second audio based on the second audio content received in fourth communication channel 508.

In step 708, a second left eye shuttering lens and a second right eye shuttering lens are shuttered in synchronism with the second alternating left and right images according to the second frame sync signal to enable a second wearer of the second slave device to perceive the second alternating left and right images as a second three-dimensional image. For example, as described above, a left eye shuttering lens and a right eye shuttering lens of glasses 112b may be shuttering in synchronism with the second alternating left and right images displayed by display system 102. The second frame sync signal provided in third communication channel 506 causes the left eye shuttering lens to be open and the right eye shuttering lens to be closed when the second left image is displayed by display system 102, and causes the left eye shuttering lens to be closed and the right eye shuttering lens to be open when the second right image is displayed by display system 102.

In this manner, two users can simultaneously be delivered independent three-dimensional content by display system 102. Display system 102 displays a pair of right and left images for each user that are interleaved with each other, each pair of right and left images corresponding to a three-dimensional image. Furthermore, display system 102 streams audio content for each user that is associated with the corresponding three-dimensional image viewed by the user. Further users may additionally be delivered independent three-dimensional content by display system 102 in a similar manner (e.g., as described in flowchart 700 for the second user). The number of users that are enabled to be delivered independent three-dimensional content by display system 102 may be limited by a number of slave devices that can join the device network, if a limit exists.

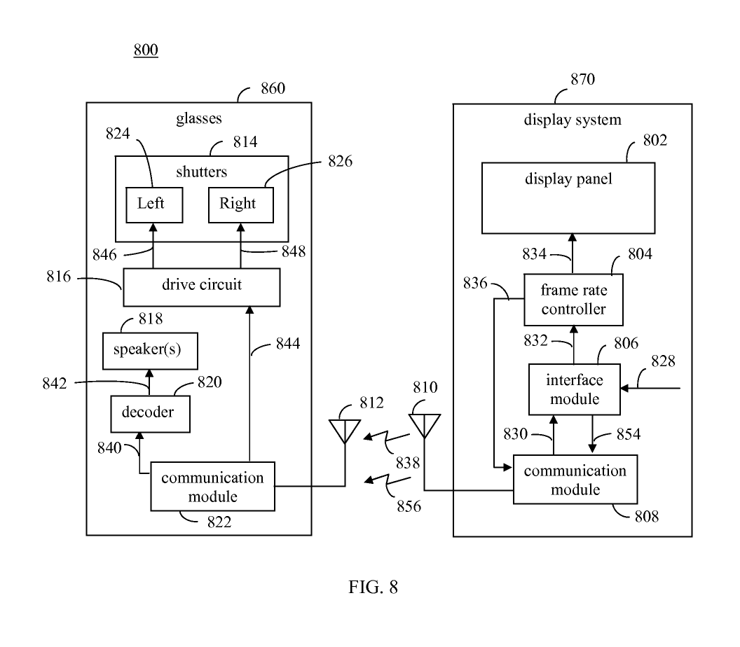

Glasses 112a and 112b and display system 102 may be configured in various ways to perform their respective functions. For instance, FIG. 8 shows a block diagram of a communications system 800 that includes glasses 860 and a display system 870, according to an example embodiment. Glasses 860 of FIG. 8 are an example of each of glasses 112a and 112b, and display system 870 is an example of display system 102. As shown in FIG. 8, display system 870 includes a display panel 802 (e.g., a liquid crystal display (LCD) panel), a frame rate controller 804, an interface module 806, a first communication module 808, and an antenna 810. Glasses 860 include an antenna 812, shutters 814, analog drive circuitry, one or more speakers 818, a decoder 820, and a second communication module 822. Shutters 814 include a left shuttering lens 824 and a right shuttering lens 826. These elements of system 800 are described as follows.

In FIG. 8, a media content signal 828 is received by interface module 806. Media content signal 828 may be one or more signals that include image content (e.g., MP3 data or other form of image/video data) and audio content associated with one or more sets of three-dimensional media content. Media content signal 828 may be received from storage in display system 870 (e.g., a memory device, a hard disc drive, a DVD (digital video disc) player, etc.) or from a source external to display system 870 (e.g., a cable service provider, the Internet, a satellite television source, etc.). Interface module 828 provides an interface for receiving media content signal 828, optionally decoding and/or decompressing image data included in media content signal 828. As shown in FIG. 8, interface module 828 outputs an image content signal 832, which includes image content extracted from media content signal 828, and outputs an audio content signal 854, which includes audio content extracted from media content signal 828.

Frame rate controller 804 receives image content signal 832. Frame rate controller 804 generates a frame sync indicator 836 and image content 834 based on image content signal 832. Frame rate controller 804 provides image content 834 to display panel 802 in a manner such that display panel 802 displays a sequence of images associated with one or more three-dimensional views provided to viewers. For example, if a single three-dimensional view is being provided to a single glasses 860 that is formed by alternating display of a left image and a right image, frame rate controller 804 provides a sequence of the alternating left and right images to display panel 802 for display in a manner that is synchronized with frame sync indicator 836. Frame sync indicator 836 indicates a timing of the alternate display of the left and right images. If a pair of three-dimensional views is being provided to first and second glasses 860 (e.g., glasses 112a and 112b) that are formed by alternating display of a first left image, a first right image, a second left image, and second right image, frame rate controller 804 provides a sequence of the alternating first left, first right, second left, and second right images to display panel 802 for display, and indicates the timing of the sequential display of the first left image, the first right image, the second left image, and the second right image in frame sync indicator 836. Additional three-dimensional views may be handled in a similar manner.

Note that display panel 802 may be implemented in any suitable manner, including as a liquid crystal display (LCD) panel, a plasma display, etc.

Furthermore, note that frame rate controller 804 can provide two (or more) two-dimensional images for display by display panel 802 to two (or more) viewers. If a pair of different views is being provided to first and second glasses 860 (112a and 112b) that are formed by alternating display of a first image and then a second image, frame rate controller 804 provides a sequence of the alternating first and second images to display panel 802 for display, and frame sync indicator 836 indicates the timing of the sequential display of the first and second images. Additional views may be handled in a similar manner. Still further, frame rate controller 804 can enable display panel 802 to display one or more two-dimensional images interleaved with one or more three-dimensional images, in a similar manner. Frame rate controller 804 may be implemented in hardware, software, firmware, or any combination thereof, including in analog circuitry, digital logic, software/firmware executing in one or more processors, and/or other form.

Frame sync indicator 836 may be used to enable the passing and blocking of light by the shuttering lenses of wearable devices to be synchronized with the corresponding images displayed by display device 802. As shown in FIG. 8, frame sync indicator 826 is output by frame rate controller 804, and is received by communication module 808. Communication module 808 may be configured to wirelessly communicate according to any suitable protocol mentioned elsewhere herein or otherwise known. For instance, in an embodiment, communication module 808 may include a Bluetooth™ module (e.g., a Bluetooth™ receiver/transmitter chip) configured to enable communications according to a Bluetooth™ standard. In an embodiment, communication module 808 may capture a value of a Bluetooth™ clock of the Bluetooth™ module on an edge (e.g., a rising edge) of frame sync indicator 826, and the captured clock value may be included in the frame sync signal transmitted by display system 870 to glasses 860.

Communication module 808 also receives audio content 854 from interface module 806. Communication module 808 transmits the captured clock value and/or other indication of frame sync indicator 826 in a first communication signal 838, and the audio content of audio content 854 that is associated with the image content delivered to glasses 860 in a second communication signal 856 (e.g., similarly to first and second communication channels 502 and 504 of FIG. 5) to glasses 112. If a second three-dimensional content for a second glasses 860 is being processed, communication module 830 may transmit the audio content associated with the second three-dimensional content and the captured clock value and/or other indication of frame sync indicator 826 over third and fourth communication channels, respectively (e.g., third and fourth communication channels 506 and 508 of FIG. 5) to the second glasses 860. Additional glasses 860 displaying additional three-dimensional content may be handled in a similar manner.

As shown in FIG. 8, communication module 822 of glasses 860 receives first and second communication signals 838 and 856 via antenna 812. Each additional glasses 860 receives the corresponding audio content and frame sync information at their corresponding communication module 822. In an embodiment, communication module 822 may include a Bluetooth™ module configured to enable communications according to a Bluetooth™ standard. Communication module 822 in glasses 860 may use the information in first communication signal 838 (e.g., the captured clock value) to generate switching signals used to open or close left and right shuttering lenses 824 and 826 of glasses 860 in synchronization with the right and left images displayed by display panel 802. For example, as shown in FIG. 8, communication module 822 may generates a frame sync signal 844. Frame sync signal 844 is received by drive circuit 816. Drive circuit 816 may include analog drive circuitry and/or digital logic configured to drive left and right shuttering lenses 824 and 826 according to frame sync signal 844.

Drive circuit 816 drives left and right shuttering lenses 824 and 826 according to the frame synch signal to block or pass light received from display panel 802 timed with the corresponding left and right images desired to be delivered to the wearer of glasses 860. Left and right shuttering lenses 824 and 826 may be any type of shuttering lenses, including liquid crystal shutters, etc. As shown in FIG. 8, driver circuit 816 generates a left drive signal 846 and a right drive signal 848. Left drive signal 846 is received by left shuttering lens 824, and right drive signal 848 is received by right shuttering lens 826. Left drive signal 846 may a first level or value configured to cause left shuttering lens 824 to open (to pass the light of the left image displayed by display panel 802) and a second level or value configured to cause left shuttering lens 824 to close (to block light). Right drive signal 848 may a first level or value configured to cause right shuttering lens 826 to open (to pass the light of the right image displayed by display panel 802) and a second level or value configured to cause right shuttering lens 826 to close (to block light).

Furthermore, communication module 822 outputs a received audio content signal 840 that includes the audio content received in second communication signal 856. Decoder 820 receives audio content signal 840. Decoder 820 (e.g., an audio codec) may be present to decode the received audio content (e.g., according to an audio standard) to generate decoded audio data, and may convert the decoded audio data from digital to analog form (e.g., converted to an analog audio signal using a digital-to-analog converter). As shown in FIG. 8, decoder 842 outputs an analog audio signal 842. Analog audio signal 842 is received by speaker(s) 818 (e.g., one or more earphones) to cause audio to be played to the wearer of glasses 860. In this manner, the wearer of glasses 860 is enabled to view the content selected for viewing by left and right shuttering lenses 824 and 826, and to hear the audio content associated with the content being viewed through speaker(s) 818. Furthermore, speaker(s) 818, when earphone(s), enable the wearer of glasses 860 to hear the audio content associated with the content being viewed without disturbing other nearby persons.

Note that the embodiment of glasses 860 shown in FIG. 8 is provided for purposes of illustration, and is not intended to be limiting. In further embodiments, glasses 112a and 112b may be configured in other ways than as glasses 860 of FIG. 8, as would be known to persons skilled in the relevant art(s) from the teachings herein. Note that communication module 822, drive circuit 816, and decoder 820 of glasses 860 may be referred to as a content delivery enabling module for glasses 860, because communication module 822, drive circuit 816, and decoder 820 enable received audio content to be played at glasses 860, and image content displayed by display system 870 to be viewed at glasses 860. Glasses 860 and/or display system 870 may each include hardware, software, firmware, or any combination thereof, to enable their respective functions described herein, including analog circuitry, digital logic, software/firmware executing in one or more processors, etc. Software and/or firmware of glasses 860 and/or display system 870 may be stored in a computer readable medium therein, such as a memory device, a hard disc drive, a removable storage drive, and/or other storage device type.

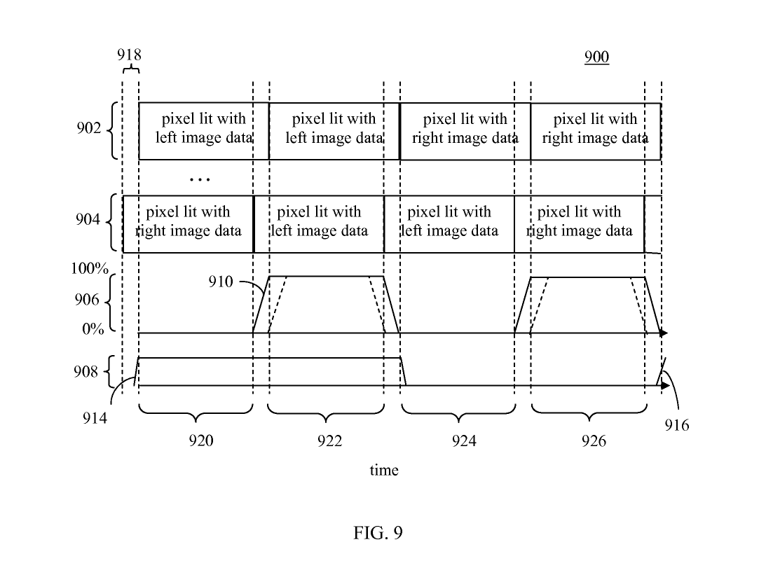

FIG. 9 shows a timeline 900 illustrating a timing of right and left images being displayed on display panel 802 of FIG. 8, according to an example embodiment. The example of FIG. 9 describes how a single three-dimensional view may be displayed by display panel 802 for purposes of illustration, but may be extended to handle the display of multiple three-dimensional views by display panel 802.

In an embodiment, display panel 802 may include an array of pixels (e.g., an array of LCD pixels, LED pixels, etc.). A first row 902 in FIG. 9 illustrates image content of image content 834 that is displayed by a first pixel of the pixel array of display panel 802 (e.g., a top left pixel—the first pixel in the first row of the pixel array), and a second row 904 in FIG. 9 illustrates image content of image content 834 that is displayed by a last pixel of the pixel array (e.g., a bottom right pixel—the last pixel in the last row of the pixel array). As shown in first row 902, the first pixel is illuminated with first left image data starting at the beginning of a first time period 920. Each subsequent intermediate pixel (not indicated in FIG. 9) of the pixel array between the first pixel and the last pixel is illuminated with corresponding first left image data, until as indicated in second row 904 in FIG. 9, the last pixel is illuminated with corresponding first left image data starting at the end of first time period 920 (after having been illuminated with old right image data during the first time period, as indicated in FIG. 9). As indicated in FIG. 9, each subsequent intermediate pixel of the pixel array is illuminated with the corresponding first left image data a little later than the immediately prior pixel of the pixel array.

A third row 906 of FIG. 9 shows a signal 910 internal to glasses 860 indicating time periods in which the left and right shuttering lenses 824 and 826 of glasses 860 are passing or blocking light. As indicated in FIG. 9, during first time period 920 where signal 910 has a low value, left and right shuttering lenses 824 and 826 are both blocking light. A typical frequency for signal 910 is ˜60 Hz (e.g., 59.94 Hz) (e.g., for a full cycle of left and right images), although further frequencies are possible, such as 240 Hz. The value for signal 910 begins to transition to a high level at the end of first time period 920, and continue to be high through second time period 922. Due to the high value for signal 910, during second time period 922, left shuttering lens 824 passes light and right shuttering lens 826 blocks light. As such, the first left image data being displayed by display panel 802 (by all pixels of the pixel array, including the first and last pixels indicated in rows 902 and 904) is passed by left shuttering lens 824 to be viewed by the left eye of the wearer of glasses 860.

As indicated by third row 906 in FIG. 9, the value for signal 910 begins to transition to a low level at the end of second time period 922, where it remains low during a third time period 924. Due to the low level of signal 910 during third time period 924, left and right shuttering lenses 824 and 826 both block light, and display panel 802 transitions to displaying right eye data. As shown in first row 902 in FIG. 9, the first pixel is illuminated with first right image data starting at the beginning of third time period 924. Each subsequent intermediate pixel of the pixel array is illuminated with corresponding first right image data, until as indicated in second row 904 in FIG. 9, the last pixel is illuminated with corresponding first right image data starting at the end of third time period 924 (after having been illuminated with the first left image data during second time period 922 and a portion of third time period 924). Due to the high value for signal 910, during a fourth time period 926, right shuttering lens 826 passes light and left shuttering lens 824 blocks light. As such, the first right image data being displayed by display panel 802 (by all pixels of the pixel array, including the first and last pixels indicated in rows 902 and 904) is passed by right shuttering lens 826 to be viewed by the right eye of the wearer of glasses 860.

This sequence illustrated in FIG. 9 is repeated for second left and right image data, third left and right image data, etc., to enable the wearer of glasses 860 to be delivered a three-dimensional view. If additional three-dimensional views are delivered to wearers of additional glasses 860, display panel 802 is illuminated with corresponding right and left image data for the additional glasses 860 in an interleaved sequence with the right and left image data for the first glasses 860.

A fourth row 908 of FIG. 9 shows a graphical representation of a frame sync indicator 914 associated with glasses 860. For example, frame sync indicator 914 is an example of frame sync signal 844 of glasses 860. As shown in fourth row 908, frame sync indicator 914 has a first value when left image data is being displayed by display panel 802 (e.g., has a high value) and has a second value when right image data is being displayed by display panel 802 (e.g., has a low level) for a particular three-dimensional content. In an embodiment, drive circuit 816 receives frame sync indicator 914, and generates left and right shutter drivers 846 and 848 based on frame sync indicator 914. For instance, at a rising edge of frame sync indicator 914, drive circuit 816 may generate left and right shutter drivers 846 and 848 to have respective values that close left and right shutter lenses 824 and 826. Midway through this first cycle of frame sync indicator 914 while frame sync indicator 914 is high, drive circuit 816 may generate left shutter driver 846 to have a value to cause left shutter lens 824 to open (e.g., the high pulse of signal 910 shown in FIG. 9 during time period 922) (right shutter lens 826 remains closed). At a falling edge of frame sync indicator 914, drive circuit 816 may generate left and right shutter drivers 846 and 848 to have respective values that close left and right shutter lenses 824 and 826. Midway through this next cycle of frame sync indicator 914 while frame sync indicator 914 is low, drive circuit 816 may generate right shutter driver 848 to have a value to cause right shutter lens 826 to open (e.g., the high pulse of signal 910 shown in FIG. 9 during time period 926) (left shutter lens 824 remains closed). This pattern may continue to open and close left and right shutter lenses 824 and 826 in synchronism with the corresponding left and right images displayed by display device 870.

As described above, if additional three-dimensional views are delivered to wearers of additional glasses 860, display panel 802 may be illuminated with corresponding right and left image data for the additional glasses 860 in an interleaved sequence with the right and left image data for the first glasses 860. For instance, referring to FIG. 9, if a second glasses 860 is being supported, in first row 902, the pattern of left and right image data may be as follows: first glasses 860 left image data displayed in time periods 920 and 922, first glasses 860 right image data displayed in time periods 924 and 926, second glasses 860 left image data displayed in a subsequent two time periods, second glasses 860 right image data displayed in a next subsequent two time periods, first glasses 860 left image data displayed in a next subsequent two time periods, etc. Each further pixel of the pixel array after the first pixel may have a similar pattern of left and right image data in timeline 900. A second signal 910 for the second glasses 860 may be present in timeline 900 that is low through time periods 920-926, and indicates high and low levels in the subsequent four time periods (similar to the pattern of signal 910 in FIG. 9) during which the second glasses 860 opens and closes its left and right shutter lenses 824 and 826 accordingly. Additional glasses 860 may be handled in a similar manner.

Embodiments provide advantages. For instance, two Bluetooth™ enabled functions may be combined in a single device—the frame sync signal functionality and audio content functionality may be included together in a pair of 3D-enabled glasses. This enables a more user friendly experience in that separate glasses (that enable video) and a separate headset (that provides audio) are not needed. Instead, a combination device can be worn by the user that both enables video and provides audio. Furthermore, a number of members that may be included in a piconet is preserved. Because Bluetooth™ can support eight endpoints, by reducing the 3D glasses-plus-headset device (two Bluetooth™ piconet member devices) into a single Bluetooth™ piconet member device is advantageous as it preserves space in the Bluetooth™ piconet for further members (e.g., for remote control function, for other 3D glasses/headset endpoints, and/or potential other Bluetooth™ endpoints).

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A wearable device, comprising:
a glasses frame;
at least one earphone mounted to the glasses frame;
a left eye shuttering lens mounted to the glasses frame;
a right eye shuttering lens mounted to the glasses frame; and
a communication module;
the wearable device being a slave device in a device network, and a display system being a master device in the device network;
the communication module receiving from the display system a frame sync signal and audio content associated with three-dimensional image content delivered to the wearable device as alternating left and right images displayed by the display system; and
the wearable device being configured to play audio based on the received audio content using the at least one earphone.

2. The wearable device of claim 1, wherein the communication module includes a Bluetooth™ receiver.

3. The wearable device of claim 1, wherein the communication signal receives a clock value of a clock of the display system from the display system, and generates the frame sync signal based on the clock value.

4. The wearable device of claim 1, wherein the device network includes at least one additional wearable device.

5. The wearable device of claim 1, wherein the left eye shuttering lens and the right eye shuttering lens are shuttered in synchronism with the alternating left and right images according to left and right drive signals generated based on the frame sync signal to enable a wearer of the wearable device to perceive the alternating left and right images as a three-dimensional image.

6. The wearable device of claim 1, further comprising:
a decoder configured to decode the received audio content into decoded audio data; and
a digital-to-analog (D/A) converter configured to convert the decoded audio data into an analog audio signal;
the analog audio signal being received by the at least one earphone.

7. The wearable device of claim 1, wherein the device network is a piconet.

8. A method in a wearable device, comprising:
joining a device network as a slave device, the device network further including a display system as a master device in the device network, the wearable device including a glasses frame, at least one earphone mounted to the glasses frame, a left eye shuttering lens mounted to the glasses frame, and a right eye shuttering lens mounted to the glasses frame;
receiving from the display system a frame sync signal and audio content associated with three-dimensional image content delivered to the wearable device as alternating left and right images displayed by the display system; and
playing audio based on the received audio content using the at least one earphone.

9. The method of claim 8, wherein said receiving comprises:
receiving a clock value of a clock of the display system from the display system; and
generating the frame sync signal based on the clock value.

10. The method of claim 8, further comprising:
shuttering the left eye shuttering lens and the right eye shuttering lens in synchronism with the alternating left and right images according to left and right drive signals generated based on the frame sync signal to enable a wearer of the wearable device to perceive the alternating left and right images as a three-dimensional image.

11. The method of claim 10, wherein a second wearable device is joined with the device network as a second slave device, the second wearable device receiving a second frame sync signal and second audio content associated with second three-dimensional content delivered to the second wearable device as second alternating left and right images displayed by the display system, the first three-dimensional content and second three-dimensional content alternately delivered by the display system, the second wearable device having a second left eye shuttering lens and a second right eye shuttering lens, the method further comprising:
shuttering the second left eye shuttering lens and a second right eye shuttering lens in synchronism with the second alternating left and right images according to the second frame sync signal to enable a second wearer of the second wearable device to perceive the second alternating left and right images as a second three-dimensional image.

12. The method of claim 8, wherein said playing comprises:
decoding the received audio content into decoded audio data;
converting the decoded audio data into an analog audio signal; and
receiving the analog audio signal at the least one earphone.

13. The method of claim 8, wherein the device network is a piconet, said joining comprising:
joining the piconet as the slave device.

14. A content delivery enabling module in a wearable device, comprising:
a communications module configured to enable the wearable device to join a device network as a slave device, the device network further including a display system as a master device in the device network; and
drive circuitry that receives a frame sync signal via the communications module from the display system;
wherein the communications module further receives audio content from the display system, the audio content being associated with three-dimensional image content delivered to the wearable device as alternating left and right images displayed by the display system; and
the drive circuitry being configured to shutter the left eye shuttering lens and the right eye shuttering lens in synchronism with the alternating left and right images according to the frame sync signal to enable a wearer of the wearable device to perceive the alternating left and right images as a three-dimensional image.

15. The content delivery enabling module of claim 14, wherein a second wearable device is joined with the device network as a second slave device, the second wearable device receiving the frame sync signal and second audio content associated with second three-dimensional content delivered to the second wearable device as second alternating left and right images displayed by the display system, the first three-dimensional content and second three-dimensional content alternately delivered by the display system.

16. The content delivery enabling module of claim 15, wherein the second wearable device has a second left eye shuttering lens and a second right eye shuttering lens that are shuttered in synchronism with the second alternating left and right images according to the frame sync signal to enable a second wearer of the second wearable device to perceive the second alternating left and right images as a second three-dimensional image.

17. The content delivery enabling module of claim 14, wherein the communication module includes a Bluetooth™ receiver.

18. The content delivery enabling module of claim 14, further comprising:
a decoder configured to decode the received audio content into decoded audio data;
a digital-to-analog (D/A) converter configured to convert the decoded audio data into an analog audio signal;
the analog audio signal being received by an earphone of the wearable device.

19. The content delivery enabling module of claim 14, wherein the device network is a piconet.
